(19) United States
(12) Patent Application Publication
(10) Pub. No.: US 2025/0010723 A1
(43) Pub. Date: Jan. 9, 2025

(54) Self Charging Electric Vehicle System

(71) Applicant: Augustine Martin Perez, Monterey, CA (US)

(72) Inventor: Augustine Martin Perez, Monterey, CA (US)

(21) Appl. No.: 18/527,363

(22) Filed: Dec. 3, 2023

Related U.S. Application Data
(60) Provisional application No. 63/430,582, filed on Dec. 6, 2022.

(51) Int. Cl. B60L 8/00; B60L 53/52

(52) U.S. Cl. CPC B60L 8/006; B60L 53/52

(57) ABSTRACT

A self charging electric vehicle system includes a housing having an air inlet and an air outlet, an fan rotatably mounted in the housing by means of a driveshaft secured to the center of the fan, with outside ends of driveshaft attached to an electric generator, with electric generators attached to side of the housing, an air intake scoop attached to the housing to allow air to enter into and flow through the housing so as to cause the fan to rotate and thus causing the electric generator to turn creating electricity to power the electric vehicle or recharge the batteries of the electric vehicle.

### CROSS-REFERENCE TO RELATED APPLICATIONS

This application claims the benefit of provisional patent application Ser. No. 63/430,582 filed 2022 Dec. 6 by the present inventor.

### BACKGROUND—PRIOR ART

The following is a tabulation of some prior art that presently appears relevant:

| U.S. Pat. No. | Kind Code | US Patent Issue Date | Patentee |
|---|---|---|---|
| 6,182,329 | B1 | Feb. 6, 2001 | Ching-Chih Lin |
| 9,331,534 | B2 | May 3, 2016 | Robert D. Yost |
| 9,062,654 | B2 | Jun. 23, 2015 | Robert D. Yost |

At present, the majority of electric vehicles manufactured in the world rely solely on batteries for power, and these batteries need to be recharged when their power has been used up. So all electric vehicles are limited to the mileage they get between charges. Because of the current state of electric vehicle battery development, the median range for new electric vehicles is 234 miles between charges. There will need to be an infrastructure of charging stations similar to gas stations where electric vehicles can recharge their batteries. At present there are only 6,000 charging stations in the United States, not nearly enough to allow for long range trips to various places in the United States. Also some power plants use coal to generate electricity which contributes to global warming. Limited mileage range is drawback for consumers and the main reason why consumers choose not to purchase electric vehicles. What car manufacturers are looking for is a way to extend the mileage of electric vehicles. What is needed is an internal system that an electric vehicle can use, to generate its own power while operating. The air flowing over any vehicle as it operates, generates force or kinetic energy. This force can be used to generate power by an electric vehicle. One such manufacture of electric vehicles have designed their vehicle to use air to generate power, Their design allows for their vehicle to produce 10 percent of their normal operating power. Long trips are not possible. Solar-power can also be used by electric vehicles to generate power. Two car manufacturers are both developing solar-powered electric vehicles. Both still rely on batteries and recharging. These electric vehicles with solar-panels are able to add up to 40 miles per day. This is not very much and long trips are not possible.

In conclusion, insofar as I am aware, the current state of electric vehicle development with its limited mileage range and limited battery recharging infrastructure makes owning an electric vehicle, not the best option for consumers.

### SUMMARY

A system that an electric vehicle can use to generate its own power by utilizing the air that flows over the vehicle as it is moving. In accordance with one embodiment, this system would have an air intake scoop that is attached to an impeller fan housing. An impeller fan that is rotatably mounted in the impeller fan housing by means of a driveshaft that runs perpendicular to the impeller fan hub and through the central axis of the impeller fan hub. Each end of the driveshaft are rotatably mounted to an electric generator motor which are attached to the sides of the impeller fan housing.

### Advantages

Accordingly, several advantages of one or more aspects are as follows: it is a unit all in itself and can be manufactured to any size or dimension, making it possible to be placed at any location inside an electric vehicle with an opening on the electric vehicle to allow air to enter the air intake scoop. Multiple units of different sizes can be placed on an electric vehicle with smaller units being placed on an electric vehicle to be used when the vehicle is traveling at slower speeds when the air is less forceful. Larger units can be placed on an electric vehicle to be used when the vehicle is traveling at higher speeds when the air is more forceful. This system becomes especially useful when traveling on the highway over long distances. It can be placed on any type of electric vehicle including motorcycles, cars, freight trucks, buses, trains, boats and airplanes. The air intake scoop is designed to compress the air increasing its force. The housing is designed so as to encase only the impeller fan blades, with the opening for the impeller fan wide enough for the impeller fan hub to rotate. With the electric generator motors attached to the sides of the impeller fan housing. the impeller fan housing is completely sealed off making sure no air escapes, ensuring that the air retains most of its force as it flows through the housing. The housing is designed in a circular shape enabling the air to continually apply its force to the impeller fan blades as the air runs its course through the housing. The air exhaust port can be ducted so the air exiting is used to help propel the vehicle forward and also channeled to the electric generator motor to help keep them cool. It can be manufactured from a variety of materials including some plastics, certain metals, and carbon fiber. In still another embodiment the system can also be used as a wind turbine. With a larger air intake scoop and placed in a highly windy area the system can use the wind to generate electricity. Still further advantages will become apparent from a study of the following description and the accompanying drawings.

### DRAWINGS

FIG. 1 is a perspective right-sided view of a Self Charging Electric Vehicle System 10 constructed in accordance with one embodiment.

FIG. 2 is a perspective front right-side view of a Self Charging Electric Vehicle system 10 as shown in FIG. 1 showing an electric generator motor 72 on each side of the impeller fan housing 20.

FIG. 3 is a right-side perspective view of a self charging electric vehicle system 10 as shown in FIG. 1 with air intake scoop 12 detached from impeller fan housing 20.

FIG. 4 is an exploded right-side view of the self charging electric vehicle system 10 as shown in FIG. 1 without air scoop 12.

FIG. 5 is a partial exploded left-side perspective view of a self charging electric vehicle system 10 as shown in FIG. 1. showing housing (side A) 22 with an electric generator motor 72 and driveshaft section 48.

FIG. 6 is a partial exploded right-sided perspective view of a self charging electric vehicle system 10 as shown in FIG. 1 housing (side B) 24 with an electric generator motor 72 and driveshaft section 44.

FIG. 7 is a right-sided perspective view of impeller fan 52 in its proper location with respect to housing (side A) 22.

FIG. 8 is a right-side perspective view of impeller fan 52 of a self charging electric vehicle system 10 as shown in FIG. 1 with impeller fan blade 54 consisting of an upper section 56 and a lower section 60.

FIG. 9 is a right-side perspective view of driveshaft section 48 and driveshaft section 44 of a self charging electric vehicle system 10.

FIG. 10 shows a right-side perspective view of air intake scoop 12 of a self charging electric vehicle system 10.

FIG. 11 is a left-side perspective view of housing (side A) 22 of a self charging electric vehicle system 10.

FIG. 12 is a right-side perspective view oh housing (side B) 24 of a self charging electric vehicle system 10.

FIG. 13 is a right-side plan cross sectional view of self charging electric vehicle system 10 showing how air enters through air intake scoop 12 and is directed through to impeller fan housing 20 with impeller fan 52 in its proper position with respect to impeller fan housing 20.

Air flows completely through impeller fan housing 20 causing impeller fan 52 to rotate and then exit air exhaust port 34.

FIG. 14 is a right-side perspective cross sectional view of impeller fan housing 20 and impeller fan 52. Impeller fan hub opening 30 is designed to be wide enough to allow impeller fan hub 58 to rotate with a minimum loss of air escaping impeller fan housing 20.

FIG. 15 is a right-side perspective cross sectional view of impeller fan housing 20.

FIG. 16 shows a right-side perspective view of a self charging electric vehicle system 10 in accordance with another embodiment. Air intake scoop 12A is larger and is shown detached from self charging electric vehicle system 10.

FIG. 17 is a perspective front right-side view of air intake scoop 12A in accordance with another embodiment.

FIG. 18 is a right-side perspective view of air intake scoop 12A in accordance with another embodiment.

### DETAILED DESCRIPTION

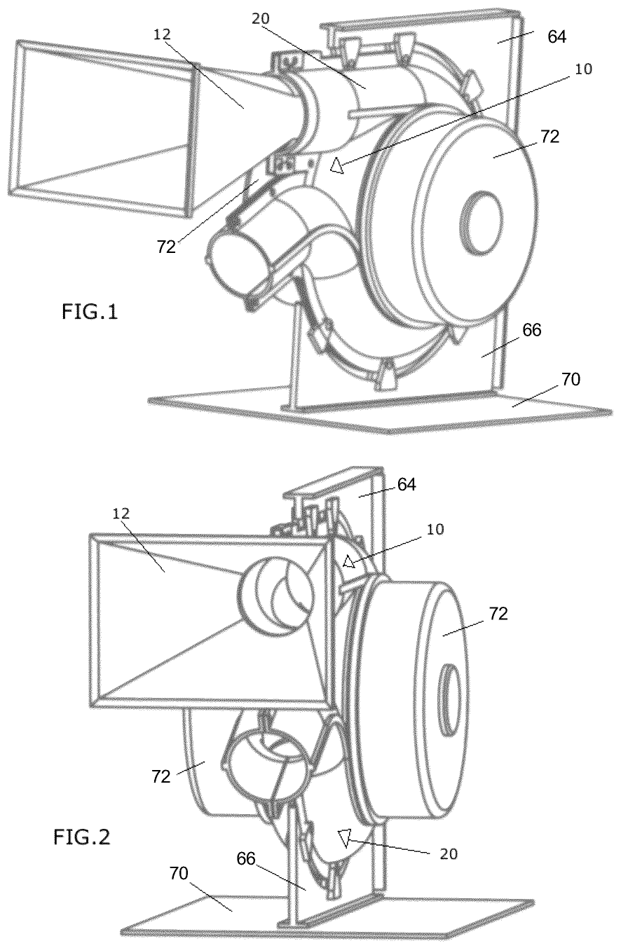

FIG. 1 is a right-side perspective view of a self charging electric vehicle system 10 constructed in accordance with one embodiment. A self charging electric vehicle system 10 consist of a air intake scoop 12, impeller fan housing 20, attachment bracket (top) 64, attachment bracket (bottom) 66, base 70, and electric generator motors 72. Other parts consisting of internal and external parts will be mentioned in further parts of the description.

FIG. 2 is a front right-side perspective view of a self charging electric vehicle system 10 showing an electric generator motor 72 attached to each side of impeller fan housing 20.

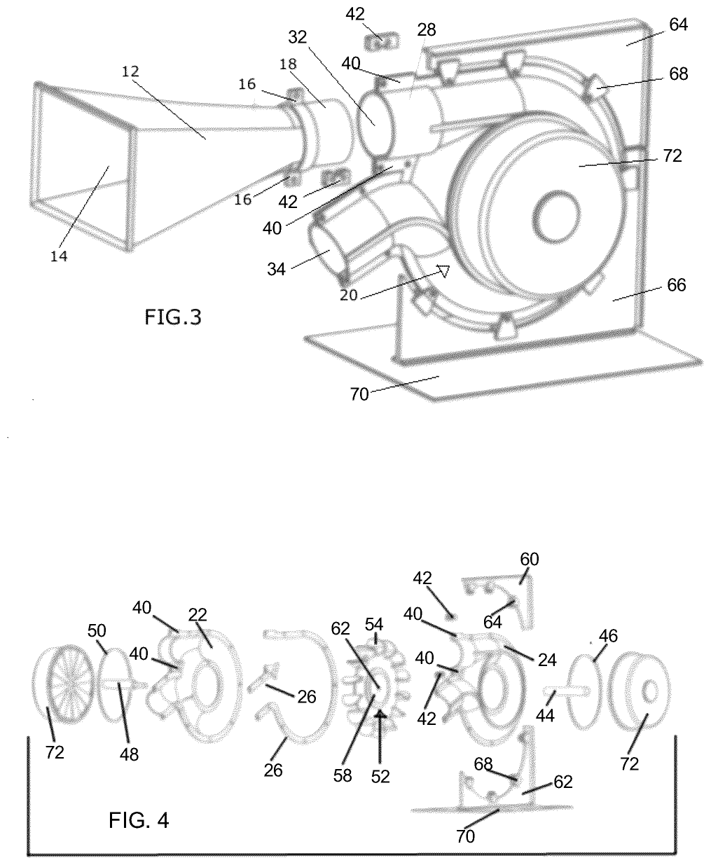

FIG. 3 is a right-side perspective view of self charging electric vehicle system 10, showing how air intake scoop 12 is attached to impeller fan housing 20. Air intake scoop connector 18 slides into air intake port connector 28. Air intake scoop 12 is held secure to impeller fan housing 20 by air intake scoop fasteners 42 which are secured to attachment points 16 and 40.

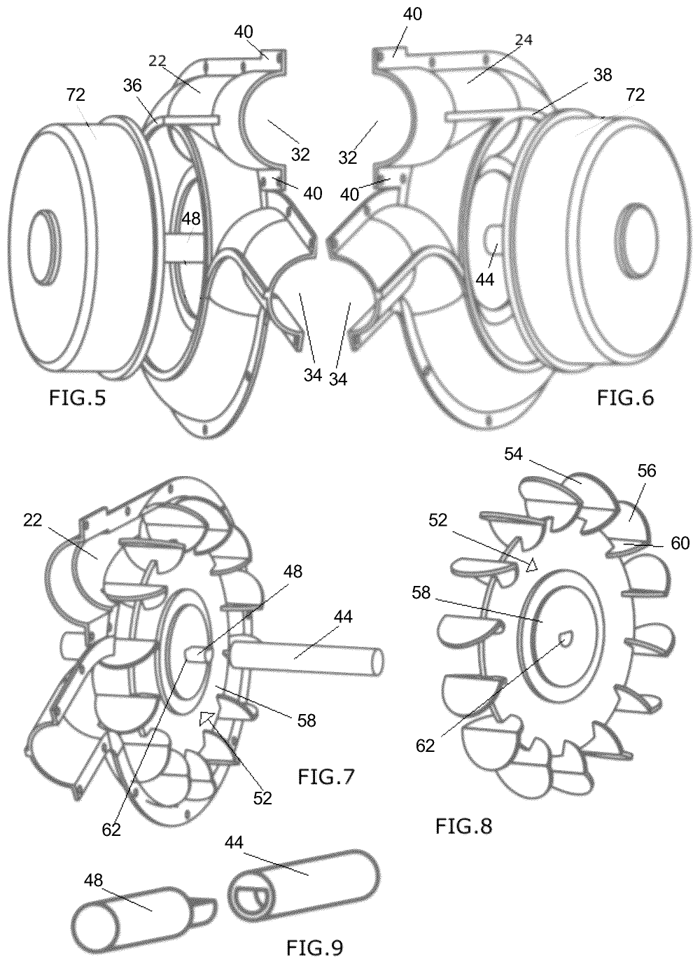

FIG. 4 is an exploded right-side view of a self charging electric vehicle system 10 that does not include air intake scoop 12. A self charging electric vehicle system 10. in accordance with one embodiment, comprises of housing (side A) 22 and housing (side B) 24 coupled with each other to form an impeller fan housing 20. With air intake port 32 and air exhaust port 34 (FIG. 3). Gasket 26 is placed between housing (side A) 22 and housing (side B) 24 to help make impeller fan housing airtight. An impeller fan 52 that is rotatably mounted in impeller fan housing 20 by means of driveshaft section 48 and driveshaft section 44 (FIG. 7) that run perpendicular to the impeller fan hub 58 and through the center hole for impeller fan driveshaft 62 (FIG. 8). Each opposite end of driveshaft section 48 and driveshaft section 44 are rotatably mounted to an electric generator motor 72 (FIGS. 5 and 6). The electric generator motors 72 are attached to sides of impeller fan housing 20 at attachment rim 36 on housing (side A) 22 (FIG. 5) and attachment rim 38 on housing (side B) 24 (FIG. 6).

Gasket 50 is placed between electric generator motor 72 and attachment rim 36 on housing (side A) 22 (FIG. 4), and gasket 46 is placed between electric generator motor 72 and attachment rim 38 on housing (side B) 24 (FIG. 4), to help make impeller fan housing airtight.

Housing (side A) 22 and housing (side B) 24 are coupled together and held secure by attachment clips 68 which are attached to attachment bracket (top) 64 and attachment bracket (bottom) 66. Base 70 is attached to attachment bracket (bottom) 66 (FIG. 3).

FIG. 5 is a left-side perspective view of housing (side A) 22 with electric generator motor 72 in position to be attached to housing (side A) 22 at attachment rim 36 with driveshaft section 48 shown attached to the center of electric generator motor 72.

FIG. 6 is a right-side perspective view of housing (side B) 24 with electric generator motor 72 in position to be attached to housing (side B) 24 at attachment rim 38 with driveshaft section 44 shown attached to electric generator motor 72.

FIG. 7 is a right-side perspective view of impeller fan 52 positioned in its proper location in respect to housing (side A) 22. Driveshaft section 48 is in position through the center hole for impeller fan driveshaft 62 and driveshaft section 44 is in position to be attached to the end of driveshaft section 48.

FIG. 8 is a right-side perspective view of impeller fan 52 with impeller fan blade blade 54 consisting of an upper section 56 and a lower section 60.

FIG. 9 is a right-side perspective view of driveshaft section 48 and driveshaft section 44.

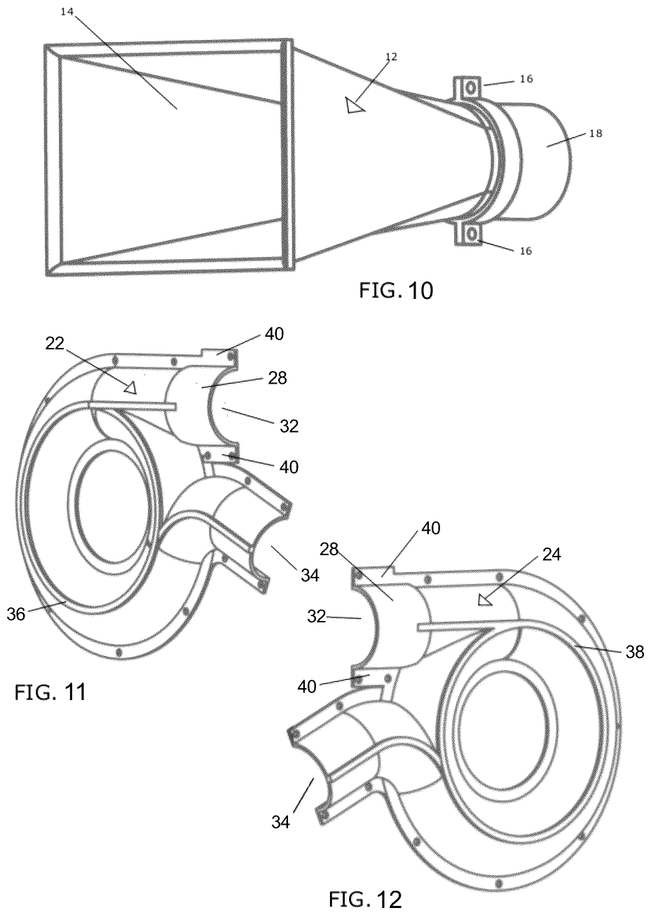

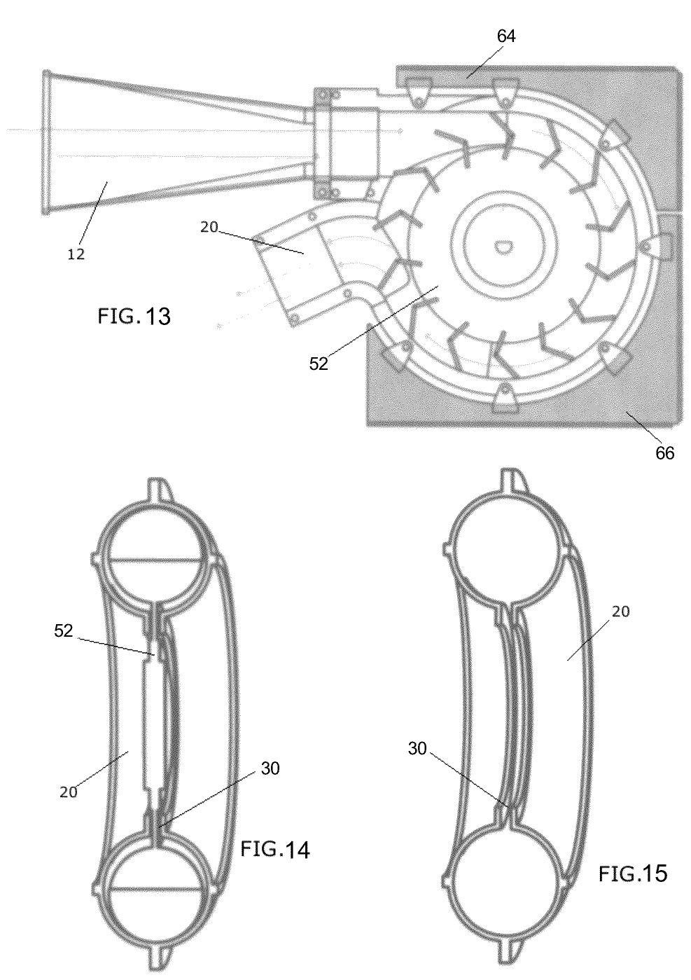

FIG. 10 is a right-side perspective view of air intake scoop 12. One or more self charging electric vehicle systems 10 are placed inside any type of electric vehicle with an opening on the electric vehicle to allow air to enter the air intake scoop air inlet 14 (FIG. 13).

FIG. 11 is a left-side perspective view of housing (side A) 22.

FIG. 12 is a right-side perspective view of housing (side B) 24.

FIG. 13 is a right-side plan cross-sectional view of the self charging electric system 10, showing impeller fan 52 in its proper location in respect to impeller fan housing 20. Air enters air intake scoop air inlet 14 (FIG. 9), passing through air intake scoop 12 and into impeller fan housing 20, causing impeller fan 52 to rotate and passing completely through impeller fan housing 20 and exiting through air exhaust port 34.

FIG. 14 is a right-side perspective cross-sectional view of impeller fan housing 20 showing impeller fan hub opening 30. Impeller fan hub opening 30 is just wide enough to allow impeller fan hub 58 to rotate, thus ensuring little to no air escaping impeller fan housing 20, limiting any negative effect on the velocity of air flowing through impeller fan housing 20.

FIG. 15 is a right-side perspective cross-sectional view of impeller fan housing 20 and impeller fan hub opening 28.

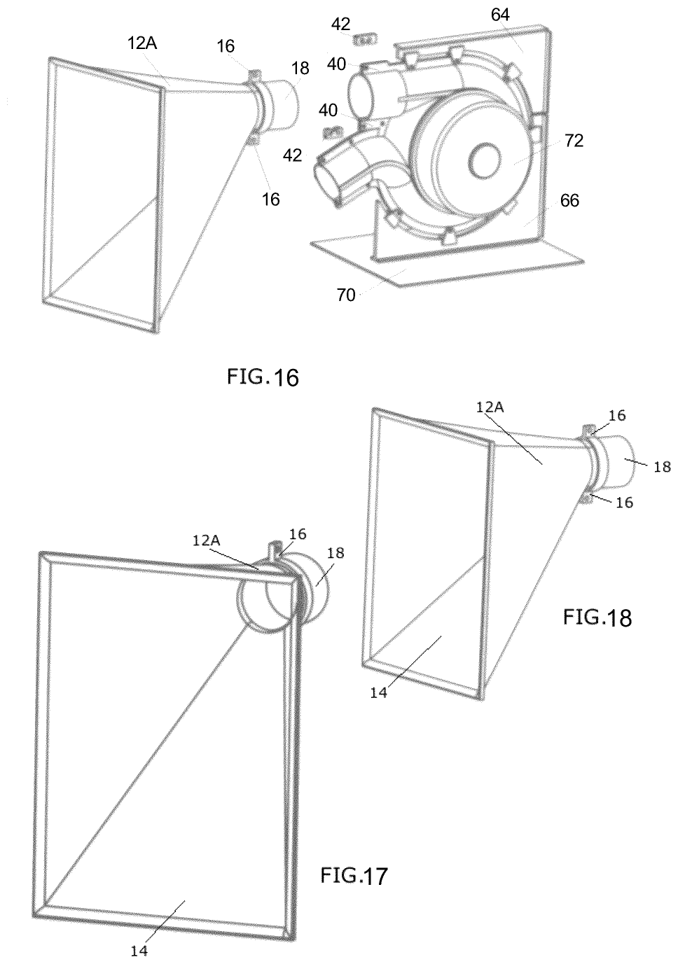

FIG. 16 is a right-side perspective view of a self charging electric vehicle system 10 constructed in accordance with another embodiment. Air intake scoop 12A can be constructed to any size or dimension, depending on what type of electric vehicle

Patent Application of Agustine M. Perez for Self Charging Electric air intake scoop 12A is being used for. The Self Charging electric vehicle system 10 can be used to generate power by using wind in a similar way a wind turbine works. Constructed with a large air intake scoop 12A, the self charging electric vehicle system 10 can be placed wherever there are strong wind currents. On top of tall buildings, rocky cliff areas, small units on top of lamp posts, anywhere a traditional wind turbine would not fit.

FIG. 17 is a front right-side perspective view of air intake scoop 12A showing a larger opening.

FIG. 18 is a right-side perspective view of air intake scoop 12A.

### REFERENCE NUMERALS

10 Self Charging Electric Vehicle System
12 Air Intake Scoop
12A. Air Intake Scoop
14 Air Intake Scoop Air Inlet
16 Attachment Points
18 Air Intake Scoop Connector
20 Impeller Fan Housing
22 Housing (side A)
24 Housing (side B)
26 Gasket
28 Air Intake Port Connector
30 Impeller Fan Hub Opening
32 Air Intake Port
34 Air Exhaust Port
36 Attachment Rim
38 Attachment Rim
40 Attachment point
42 Air intake Scoop Fastener
44 Driveshaft Section
46 Gasket
48 Driveshaft section
50 Gasket
52 Impeller Fan
54 Impeller Fan Blade
56 Upper Section
58 Impeller Fan Hub
60 Lower Section
62 Center hole for Impeller Fan Driveshaft
64 Attachment Bracket (top)
66 Attachment Bracket (bottom)
68 Attachment Clips
70 Base
72 Electric Generator Motor

### Operation

In operation a self charging electric vehicle system 10 is placed in any type of electric vehicle at a location on the vehicle, where air is flowing over the vehicle as the vehicle is moving, with an opening on the vehicle to allow air to enter the air intake scoop 12 of a self charging electric vehicle system 10 to make it operate. This opening may be an external air scoop or a NACA scoop. A self charging electric vehicle system 10 uses the kinetic energy that is created in air, as it flows over a moving vehicle, to generate power. A self charging electric vehicle system 10 can be placed in the front compartment of an electric vehicle, with an opening in the front of the vehicle to allow air to enter the air intake scoop 12. The air intake scoop 12 tapers down to a smaller opening increasing the velocity of the air before it enters the impeller fan housing 20. As air enters the impeller fan housing 20 through the air intake port 32, it causes the impeller fan 52 to rotate. The air applies continual force to the impeller fan blades 54 as the air flows through the impeller fan housing 20, and then exits through the air exhaust port 34. As the impeller fan 52 rotates, driveshaft section 44 and driveshaft 48 being connected to impeller fan 42 also rotate. Each opposite end of driveshaft section 44 and driveshaft section 48 being rotatably mounted an electric generator motor 72, causes the electric generator Motor 72 to turn, creating electricity, which is used to power the electric vehicle or to recharge the batteries. The greater the speed of the vehicle the greater the force of the air flowing over the vehicle, thus more power is created at greater speeds. It is a unit all in itself and can be manufactured to any size or dimension. Multiple units of different sizes can be placed in an electric vehicle with smaller units to be used at slower speeds and larger units to be used at faster speeds. It can be manufactured from a variety of materials including but not limited to some plastics, metals, and carbon fiber.

I claim:

1. A system an electric vehicle can use to generate power while operating, Comprising:
a housing having an air inlet and an air outlet and consisting of two casing halves coupled with each other with a gasket placed between said casing halves as to make said housing impervious, with said casing halves secured together by an upper attachment bracket and a lower attachment bracket and said lower attachment bracket being mounted on a base.
a rotor rotatably mounted in said housing,
with said rotor comprised of a hub and a plurality of vanes attached to said hub of said rotor. With said vanes having an upper section attached to a lower section at a plurality of angles.
a air-duct inlet that contains a circular compression bore with decreasing circumference that increases the velocity of air flow by funneling the air through the bore. The opening of said air duct inlet can be constructed in a plurality of sizes.

2. A system said electric vehicle can use to generate power while operating in accordance with claim 1; wherein said air-duct inlet has the means by which it can be secured to said housing, and said air-duct inlet having a first end wherein air enters and said air-duct inlet having a second end wherein air passes through to said housing,

3. A system said electric vehicle can use to generate power while operating in accordance with claim 1; wherein said housing has said rotor rotatably mounted in said housing.
a first shaft section attached to one side of said rotor, with opposite end of said first shaft section rotatably mounted to an electric motor, and said electric motor attached to side of said housing. With a second shaft section attached to other side of said rotor and opposite side of said second shaft section rotatably mounted to second electric motor with said second electric motor attached to the side of said housing, so as to cause said electric motor to rotate when said rotor rotates, creating electricity to power said electric vehicle or recharge the batteries of said electric vehicle.

4. A system said electric vehicle can use to generate power while operating in accordance with claim 1; wherein said air outlet can be placed at a plurality of positions on said impeller fan housing.

5. A system said electric vehicle can use to generate power while operating in accordance with claim 1; wherein said system can also be used to generate power in the same way a wind turbine uses wind to generate power. With larger said air-duct inlet attached to said system and said system placed in a highly windy area, said system can be used where traditional wind turbines can't be used, such as on top of tall buildings, rocky cliff areas, and on top of lamp posts.
